(19) United States
(12) Patent Application Publication
(10) Pub. No.: US 2012/0229428 A1
(43) Pub. Date: Sep. 13, 2012

(54) PORTABLE AND INTERACTIVE PRESENTATION AND DOCUMENTATION SYSTEM

(75) Inventors: Alex Tavakoli, Mettawa, IL (US); Ibrahim Khoury, Palatine, IL (US); Praveen Minumula, Des Plaines, IL (US); Ashok K. Rajpal, Bartlett, IL (US)

(73) Assignee: BOARDSHARE, INC., Evanston, IL (US)

(21) Appl. No.: 13/324,937

(22) Filed: Dec. 13, 2011

Related U.S. Application Data
(60) Provisional application No. 61/450,256, filed on Mar. 8, 2011.

(51) Int. Cl. G06F 3/033

(52) U.S. Cl. 345/179

(57) ABSTRACT

A collaborative presentation and documentation system disclosed herein allows a user to capture information from a projection surface to a document. The system includes a camera and a stylus wherein the camera that captures information from the projection surface and signals generated by a stylus. For example, the information captured from the projection surface includes the changes made with presentation system tools and an image of a document stored on a computer and projected as background. Various co-ordinate points of the projection surface are calibrated to points on the camera view. This allows the information from the captured image to be related to information on the document. The system also performs functions such as saving the captured image to the document, modifying the document, opening a new document, etc., based on signals generated by the stylus.

### REFERENCE INFORMATION

This application is based on and takes priority from the provisional patent application entitled “portable and interactive presentation and documentation system,” filed on Mar. 8, 2011, with Ser. No. 61/450,256, which and incorporated herein in its entirety by reference.

### TECHNICAL FIELD

The present application is generally directed to document creation, annotation and presentation and specifically to method and system for collaborative presentation and documentation.

### BACKGROUND

People in business and education use dry erase white boards or flip charts to communicate ideas collaboratively. The down side of these traditional aides is that they are static, non-intuitive, and do not enable interactive collaboration. When new ideas are drawn up on a traditional white board, people have to manually capture the information after the fact, by using either their cameras to take a picture of the information or by typing the details into their computer. Static collaboration is also more evident when teams try to collaborate remotely while using web collaboration software. They have to rely on viewing static presentations on their computer while they listen to others describing the information.

### SUMMARY

A collaborative presentation and documentation system disclosed herein allows a user to capture information from a projection surface to a document. The system includes a camera device, a stylus device and an application software. A usable projected area on the presentation surface is calibrated to the view of the camera device using the stylus device in collaboration with the application software. Specifically, the stylus device is used to collaborate with the camera device to provide the functionality of capturing information from a presentation surface. The camera device captures the light signal generated by the stylus device to generate the position of the stylus on the presentation surface and sends such positional information to the application software, which intelligently converts the co-ordinates of the stylus device, thus virtually making the stylus device as computer mouse on a computing device. For example, the information captured from the projection surface includes an image or a document on the computer. Furthermore, the information captured from the projection surface is also used to enhance the image or the document stored on the computer. Various co-ordinate points of the projection surface are calibrated to points on the camera view. The system also performs functions such as saving the captured information to the document, modifying the document, opening a new document, etc., based on signals generated by the stylus.

These and other features and advantages will be apparent from a reading of the following detailed description. Other implementations are also described and recited herein.

In some implementations, articles of manufacture are provided as computer program products. One implementation of a computer program product provides a tangible computer program storage medium readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTIONS OF THE DRAWINGS

A further understanding of the nature and advantages of the technology described herein may be realized by reference to the following figures, which are described in the remaining portion of the specification.

FIG. 1 illustrates an example data flow diagram of a collaborative presentation and documentation system.

FIG. 2 illustrates an example implementation of an image capturing and processing system.

FIG. 3 illustrates an example stylus device that can be used to generate and send IR signals.

FIG. 4 illustrates side views of various alternate implementations of stylus device of FIG. 3.

FIG. 5 illustrates an example calibration layout for camera calibration.

FIG. 6 illustrates one or more example operations for a calibration process.

FIG. 7 illustrates one or more operations for adjustment of the position of a camera.

FIG. 8 illustrates a collection of feature options that may be provided to the user of the presentation system disclosed herein.

FIG. 9 illustrates one or more operations for a document presentation and collaboration process.

FIG. 10 illustrates alternate implementations of various apparatuses used with the presentation system disclosed herein.

FIG. 11 illustrates an example computing system that may be used to implement the technology described herein.

FIG. 12 illustrates another example system (labeled as a mobile device 1200) that may be useful in implementing the described technology.

### DETAILED DESCRIPTIONS

Implementations of the technology described herein are disclosed herein in the context of a customized message generation system. Reference will now be made in detail to implementations of the technology described herein as illustrated in the accompanying drawings and the following detailed description to refer to the same or like parts. Throughout the specification, the term “file” should mean a file like a Word document, a comma separated value (CSV) file, etc., and the term “table” should mean a table in a database.

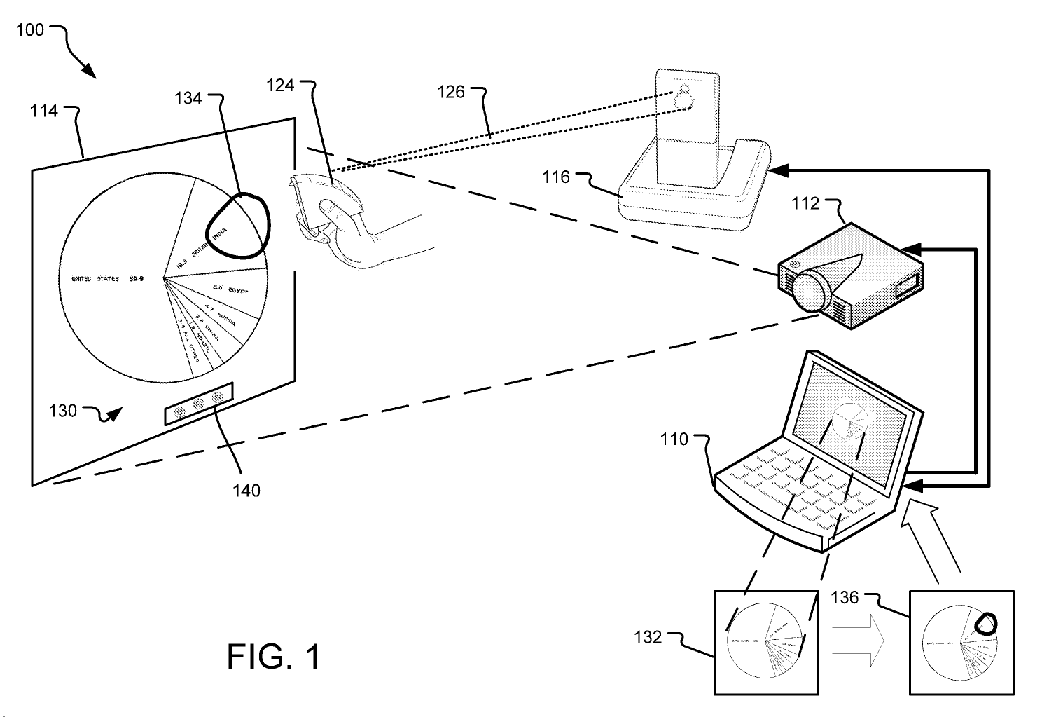

FIG. 1 illustrates an example data flow diagram of a collaborative presentation and documentation system 100 (referred to herein as the presentation system 100). The presentation system 100 uses a computer 110 connected to a projector 112 to generate a presentation on a presentation surface 114. For example, a laptop 110 with a presentation software generates a presentation on the computer 110 using a presentation document. The presentation is communicated via a communication cable to the projector 112, which projects the presentation on the presentation surface 114. The computer 110 may communicate with the projector using a VGA or HDMI cable, a USB cable, using Wi-Fi network, a Bluetooth network, etc. In an alternative implementation, the computer 110 can also be a smart-phone, a tablet device, a smart-pad device, etc. The presentation system 100 also includes a capturing device 116 that captures information presented on the presentation surface 114 and various other information necessary to document the information captured from the presentation surface and to relate such information to the presentation document on the computer 110.

In an implementation, the capturing device 116 includes a camera module with a complementary metal-oxide semiconductor (CMOS) image sensor with an infra-red (IR) filter lens. Other image sensors such as a charge-coupled device (CCD) may also be used. The image sensor tracks the IR source and translates it into an electronic signal that is further processed by a microcontroller. The sensor is configured to track an IR transmitter, a light emitting diode (LED), a light sources of similar frequency, etc. In one implementation, the capturing device 116 is implemented using a communication device such as a wireless phone, a smart-phone, etc., that includes a camera module having IR detecting capabilities. Other implementations may also use devices such as smart-pads, electronic note-pads, etc. The capturing device 116 also includes a micro-controller that processes the IR signal, the LED signal, etc., captured by the camera. In an alternative implementation, the micro-controller can be implemented as part of the computer 110. Similarly, a camera module within the computer 110 can also be used as the camera module that captures the IR signal, the LED signal, etc. In one implementation, the capturing device 116 is integrated with the projector 112.

In one implementation, the sensor of the capturing device 116 is configured by a micro-controller that also reads the data generated by the sensor. The sensor may process a signals from an IR transmitter, an LED transmitter, or other light source through the camera, and provide such signal to the microcontroller, which processes the tracking data received from the sensor via camera. The data generated by the sensor may include, for example, the size, the shape, the border the aspect ratio, etc., of the light source. In an alternative implementation of the presentation system 100, the capturing device 116 includes an ultra-low power laser that visually guides the user to align the center of its sensor to the center of the presentation surface 114.

The capturing device 116 is implemented so that the camera module captures signals from multiple IR transmitters. The sensor and micro-controller are configured to recognize and process each of such multiple signals from the multiple IR transmitters. In this manner, the presentation system 100 is capable of having multiple users participate in a presentation simultaneously. The capturing module 116 can be configured to communicate with the computer 110 using a USB cable, a Wi-Fi network, a Bluetooth network, or other suitable communication means.

The presentation system 100 also includes a stylus device 124. The stylus device 124 includes an IR transmitter, an LED transmitter, or other signal generator that transmits an IR signal, an LED signal, or other such signal that can be captured and processed by the capturing device 116. The stylus device 124 is implemented as a hand-held device that can be used by a user to point to a location on the presentation surface 114, to write on the presentation surface, to draw an image on the presentation surface, etc. In one implementation, the stylus device 124 is configured to generate efficient line of sight 126 communication with the capturing device 116. The stylus device 124 is configured to generate a signal to be sent to the capturing device 116 by using a switch located on the stylus device. In one implementation, such a switch is activated by pressing of the stylus device on a surface, such as the presentation surface 114.

In the example implementation of FIG. 1, the presentation system 100 is shown to present an image 130 on the presentation surface. For example, the image 130 is generated by the computer 110 using a document stored on the computer 110, using a document on a network that is communicatively connected to the computer 110, etc. The image 130 is illustrated as replica of an image 132 displayed on the computer 110. A user can use the stylus device 124 to annotate the image 130, to mark it up, add additional drawings thereto, etc., using the stylus device 124. For example, in the illustrated implementation, a user has marked-up 134 part of the image 130. As the user marks-up 134 that image, a signal is sent from the stylus device 124 to the capturing device 116. The capturing device 116 sends information about the mark-up 134 to the computer 110 and the mark-up is incorporated into the original image 132 used to generate the image 130. The revised figure 136 is illustrated as including the mark-up 134 therein. Subsequently, the revised figure 136 may be store in the computer 110, shared with other users, etc. For example, if the presentation document used to generate the image 130 is shared by a number of users over a communication network, such as the Internet, each of the various users at distant locations can annotate the image 130 with separate mark-ups and each of such mark-ups can be added to the revised image to be stored in the presentation document.

In an alternative implementation, the image 130 also includes a selection menu 140 or a palette listing various selection options. For example, such a selection menu 140 includes 22 buttons for various functions and utilities. Selection of these buttons can invoke different utilities based on their usage. For example, a button for opening a new presentation document, another button for closing an existing presentation document, an option button for selecting a Pen tool and a button to change the pen tip width, another button for changing the color of the mark-ups with pen tool, etc. The menu 140 also has three distinctive buttons for erasing any changes made with marks-ups and for reverting back and forth with two separate buttons namely “Redo” and “Undo.” The menu 140 also allows the user to capture the image from the presentation surface 114 with a button named “screen capture.” Another button named “shortcut” enables a user to maneuver to a deliberated folder or desktop of the computer system 110. The intended user can select one of these buttons by pressing the switch of the stylus device 124 at the location on the presentation surface 114 where such an option button is displayed. In one implementation, the menu 140 also has buttons to minimize and maximize the menu 140 or to exit the menu 140 with a button. The capturing device 116 interprets the IR signal received from the stylus device 124 based on its location and sends a signal to the computer 110 to take an action in accordance with the selected button. In one implementation, the menu 140 has a radio button indicating the status of device 124 whether the device is attached, not attached or being used for intended purpose connected to computer 110.

To ensure that the capturing device 116 relates the mark-up 134 with the appropriate part of the image 132, an implementation of the presentation system 100 allows a user to calibrate the usable projected area on the presentation surface 114 for the application software. A number of calibration methods, such as a five-point calibration method, a nine-point calibration method, etc., can be used to calibrate the usable projected area on the presentation surface 114. For example, in a five-point calibration method, a laser signal is generated from the capturing device 116 and sent to the presentation surface 114. Such pointing of the laser on the presentation surface 114 is also accompanied by presenting of a grid on the presentation surface, with the grid showing a number of calibration points including the center of the presentation surface and a number of corner points. Subsequently, the user with the stylus device 124 is requested to point to one or more of these calibration points. For example, the user can generate an IR signal with the stylus pointing to a calibration point. The capturing device 116 uses such IR signal to calibrate the position of the stylus with the calibration point. Subsequently, anytime an IR signal is received from the stylus device 124, the capturing device 116 calculates the position of the stylus device 116 based on the distance of the stylus device 124 from one of the calibration points.

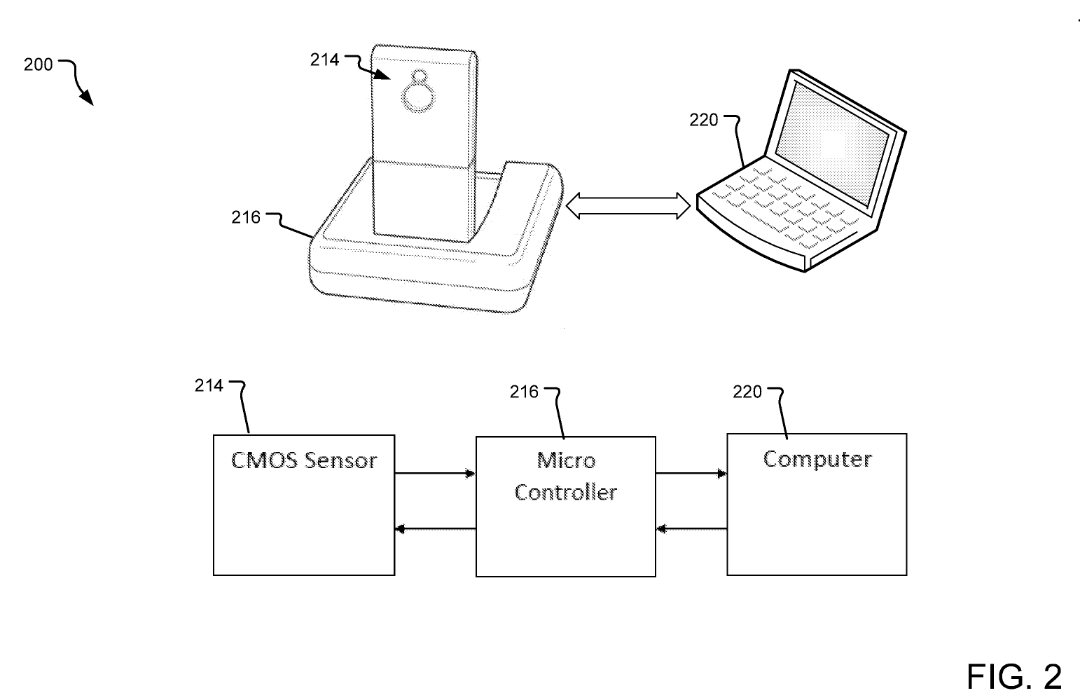

FIG. 2 illustrates an example implementation of the image capturing and processing system 200. The system 200 includes a CMOS sensor 214 attached to a microcontroller 216. In an implementation of the system 200, the CMOS sensor is replaced by a CCD sensor. The CMOS sensor 214 captures IR or other signal generated from an IR transmitter device and processes the signal to determine various information about the IR transmitter such as the distance of the IR transmitter, the position of the IR transmitter on a presentation surface, etc. The CMOS sensor 214 sends this information to the microcontroller 216, which processes the signal and sends information to a computer 220. The computer 220 can also send information to the microcontroller 216. For example, during the calibration stage, the computer 220 can send a signal to the microcontroller 216 that causes the camera hosting the CMOS sensor 214 to generate and focus a laser signal on a presentation surface.

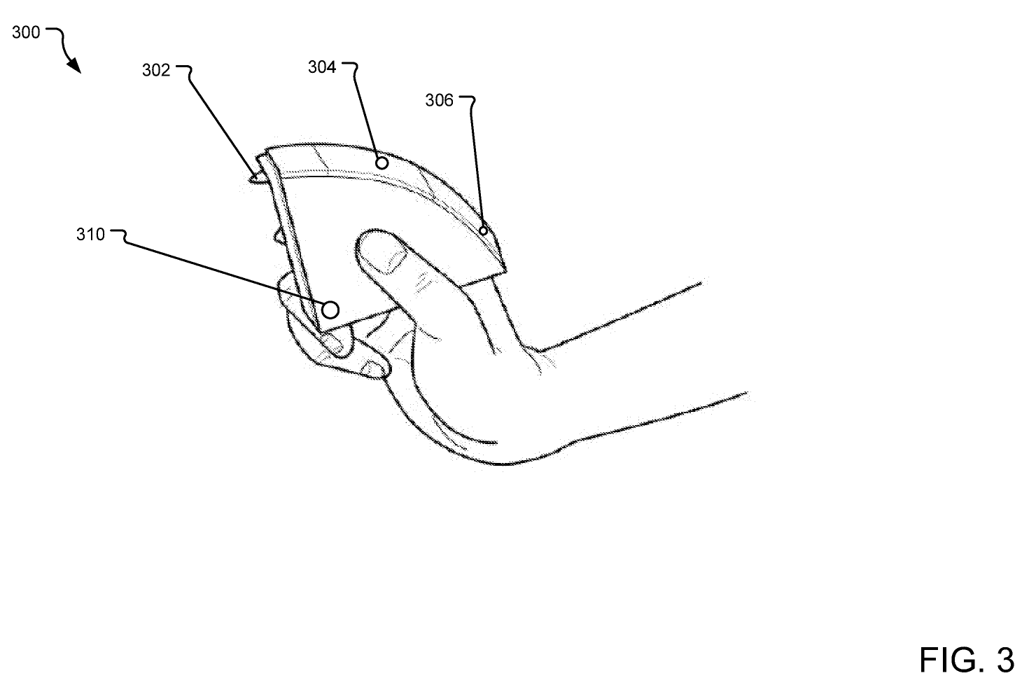

FIG. 3 illustrates a stylus device 300 that can be used to generate and send IR signals to a capturing device such as a CMOS sensor, a CCD sensor, etc. An IR emitter 304, such as an IR LED, located on the stylus device 300 generates an IR signal. In one implementation the IR emitter 304 can be activated by pressing a switch 302. The switch 302 may be implemented as a mechanical switch that is activated by pressing the switch, an electronic switch that is activated based on detection of a presentation surface within a predetermined distance of the switch, etc. In an alternate implementation, the switch 302 may also be located on a different surface of the stylus device and activated by a user by pressing the switch, etc. In one implementation, the stylus device is operated by batteries and a visual indicator 306 can provide an indication to a user about the battery status as well as the activity of the IR Transmitter 304.

The stylus device 300 is configured to optimize the line of sight communication between the IR emitter 304 and the IR capturing device. For example, the stylus device 300 may be configured to accommodate left-handed users and right-handed users with equal ease and such that irrespective of the user's inclination, the user's writing style, etc., that the line of sight communication is maintained between the IR transmitter 304 and the IR capturing device. The stylus has an ergonomic design that delivers comfort and pen like feel to a user.

The IR transmitter 304 on the stylus device 300 is turned on when the switch 302 is pressed against or is brought in proximity to a projection surface. A sensor on an IR capturing device tracks the movement of the IR transmitter 304, and therefore the stylus device 300. The IR capturing device sends such information about the location of the IR transmitter 304 to a microcontroller and/or to a computer attached thereto. In one implementation, the stylus device 300 is configured to simulate the right and center button of electronic mice used with computers. In other implementations, the stylus device 300 is configured to simulate the functionality of a joy-stick or other electronic input device used with computers. The functionality of the stylus device 300 can also be enhanced to achieve right click on a computer mice, to create shortcuts to generate a particular function on a computer, etc. In one implementation, the stylus device 300 can also be used to select a function from a list of functions projected on a projection surface. Thus, for example, by pressing the switch 302 on a projection of an “erase selection,” the stylus device 300 can be converted to an eraser that can be used to erase information from a presentation image.

An implementation of the stylus device 300 includes an internal electronic circuitry that causes the IR transmitter 304 to generate and transmit different signals in response to different selections of one or more buttons on the stylus. For example, a side button 310 provided on the side of the stylus, when pressed together with the switch 302 can be used to select an IR signal from the IR transmitter that, when processed by a microcontroller or a computer, causes a particular programmable and customizable action to take place on the computer. For example, such a customizable action is to save the presentation on the computer. As an alternate example, when the button 310 is pressed and released in a predetermined manner, the IR transmitter 304 generates IR signals of predetermined sequence and timing. In such an implementation, the IR capturing device receiving the IR signal may be configured to generate a specific code related to such a sequence of IR signals. Similarly, the computer attached to the IR capturing device is also configured to process the specific code to simulate a specific action on the computer.

The IR patterns sent by the stylus device 300 are prone to error in timing and strength of the patterns. Furthermore, it is likely that the synchronization between the stylus clock and clock of the IR capturing device is off in some situations. To account for such errors and a lack of synchronization, the stylus device 300 and any IR capturing device are provided with various protocols including one or more unique patterns communicated between them.

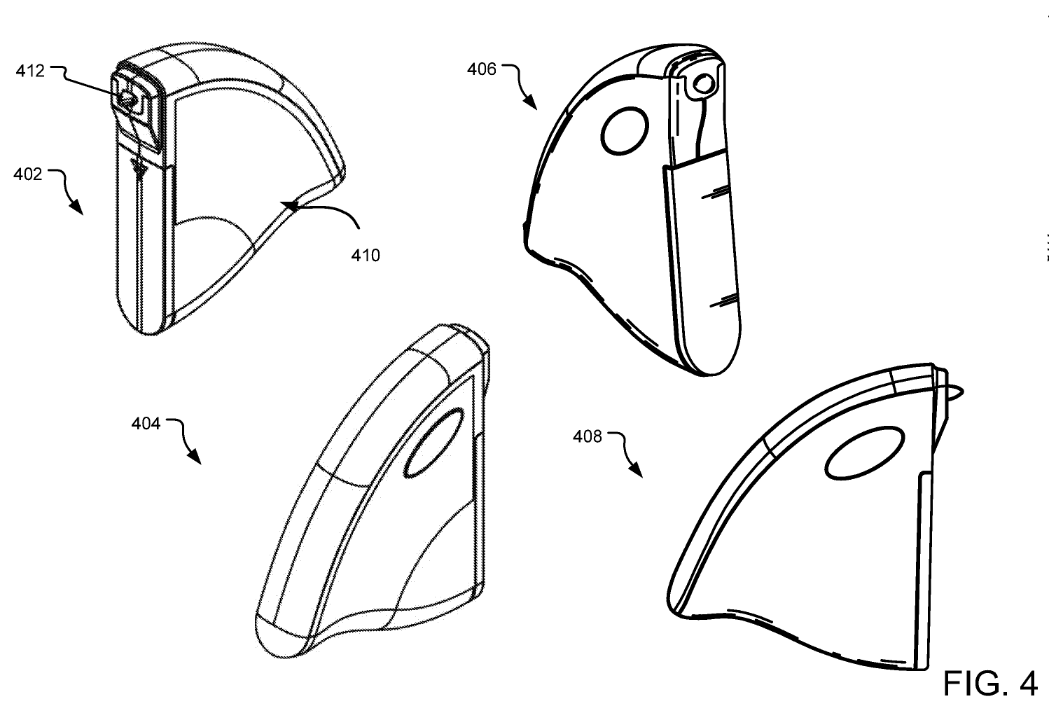

FIG. 4 illustrates perspective views 402, 404, 406 and 408 of various alternate implementations of stylus devices. The stylus 402 has a battery compartment 410 on a side of the stylus and a switch 412 on the front of the stylus 402. In an alternate implementation, the battery compartment 410 is located on the front of the stylus 402.

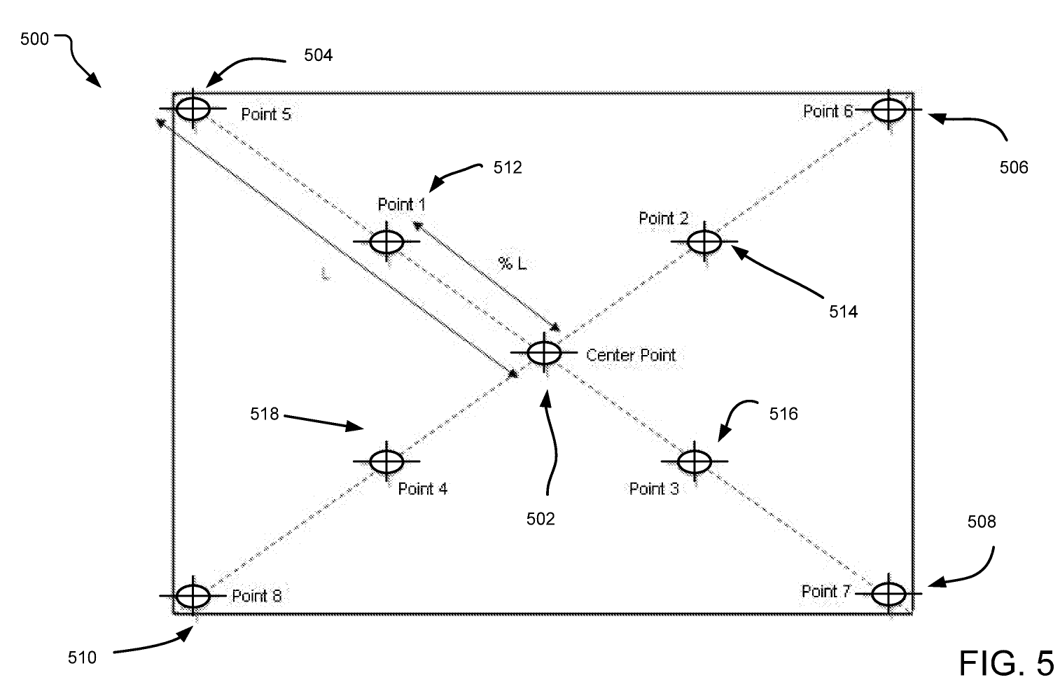

The presentation system requires a user to calibrate the IR camera coordinates with the coordinates of the presentation that is projected on a presentation surface from a computer. A calibration layout is presented on the presentation surface to allow a user to perform such a calibration. FIG. 5 illustrates an example calibration layout 500 of various calibration points used for calibration of an IR camera coordinates with the coordinates of the presentation that is projected on a presentation surface from a computer. Specifically, the calibration layout 500 includes a center point 502, four corner points 504, 506, 508, and 510 and four inner diagonal points 512, 514, 516, and 518. The calibration layout 500 can be projected on a presentation surface where the center point of the usable surface can be illuminated by a laser generated from the sensing device, such as a camera including an IR receiver. The above discussed method of calibration using the nine points 502-518 is called a nine-point calibration system. In an alternate implementation, other methods of calibration, such as five-point calibration, etc., are used.

Before using the stylus device having an IR transmitter with an IR capturing device together, the coordinates of the usable projected area on the presentation surface 114 are calibrated with the coordinates of the camera so that the information about the movement and the position of the IR transmitter on the presentation surface can be used by the computer. Specifically, the calibration process is used to map the center point 502 of the layout with a center point of a camera that captures a presentation. The four corner points 504, 506, 508, and 510 of the layout are used for warping the coordinates of an image capturing device with the coordinates of a presentation surface. The four inner diagonal points 512, 514, 516, and 518 are used to get information about placement of the camera compared to the presentation surface.

The calibration layout 500 together with a calibration process is used to validate the proper coverage of the usable projected area on the presentation surface 114 by the camera while prompting the user to move the capturing device 116 until the camera coordinates approximately calibrate with the points presented on the projected area on the presentation surface 114. Once the calibration layout 500 is presented on the calibration surface a message on the computer prompts the user to touch one of the calibration points with a stylus having an IR transmitter. When the user touches the point on the presentation surface with the stylus, the IR transmitter of the stylus sends an IR signal that is recorded and analyzed by the IR capturing device with a CMOS sensor 214 & micro controller 216. This action is repeated for other calibration points. Thus, for example, the user may be required to touch one or more of the center point 502, the corner points 504, 506, 508, and 510 and four inner diagonal points 512, 514, 516, and 518 with the stylus. The IR signal generated for each of the points that the stylus touches is recorded and analyzed by the IR capturing device. Subsequently, the capturing device, such as the CMOS camera generates information such as position, etc., regarding each IR signal and communicates such signal to the microcontroller of the IR capturing device and/or to the computer. The capturing device and/or the computer analyzes these signals to define the active presentation surface and relates it to the view of the camera within the capturing device.

Furthermore, the microcontroller attached to the IR capturing device and/or the computer also analyzes the IR signal information using an area based algorithm to suggest the user for placement of the camera to ensure that the CMOS sensor covers the entire projected area of the presentation surface. This algorithm also generates prompts to the user to place the camera at a proper distance from the presentation surface and to turn the camera up or down and left or right in relation to a fixed axis.

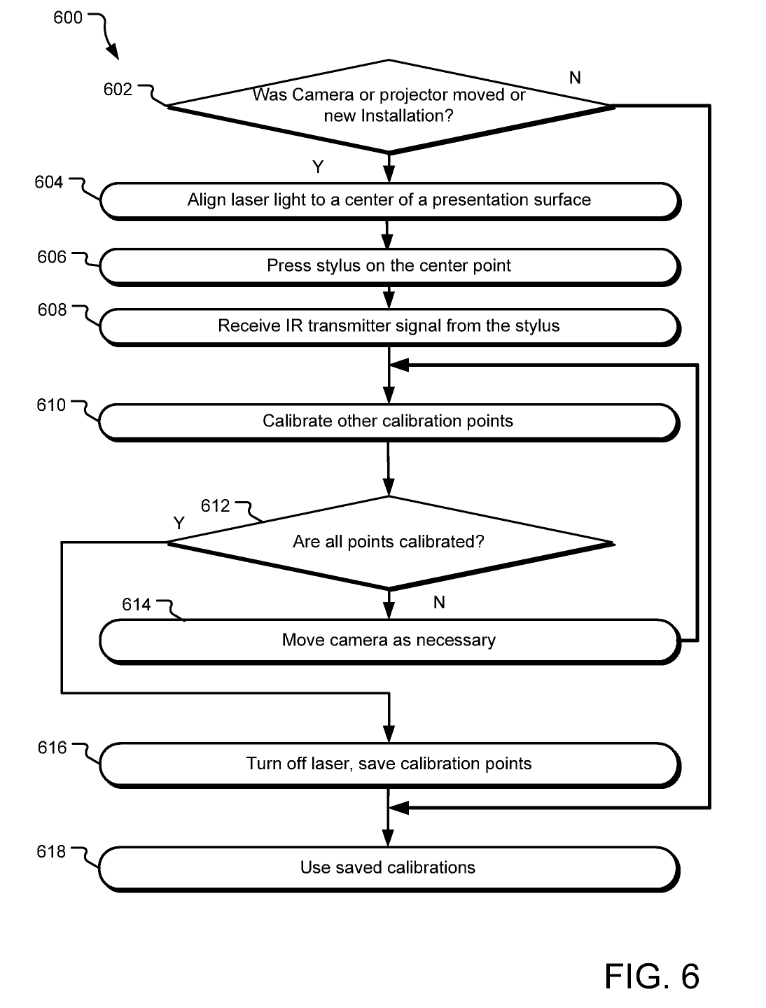

When the presentation system disclosed herein is used for the first time, or after the position of the camera of the presentation system is moved with respect to the presentation surface, a program executed on a computer guides the user through the calibration process. FIG. 6 illustrates one or more operations for such a calibration process 600. An operation 602 asks the user to identify if this is a new installation of the presentation system or if a camera or a projector of used by the system were moved since the last installation with respect to a presentation surface. If it is determined that the camera or the projector was moved or that if this is a new installation, the calibration process 600 undertakes a number of operations to recalibrate the camera view with respect to the presentation view.

Specifically, an operation 604, aligns a laser light to a center of a presentation surface. The presentation surface may be a whiteboard, a wall, or any other surface that is used for presentation by the user. A message is displayed on the computer that generates the presentation that requests the user to press the stylus on or near the location of the laser point illumination on the presentation surface. Once the user presses 606 the stylus at the center point, an operation 608 receives an IR signal from the IR transmitter attached to the stylus.

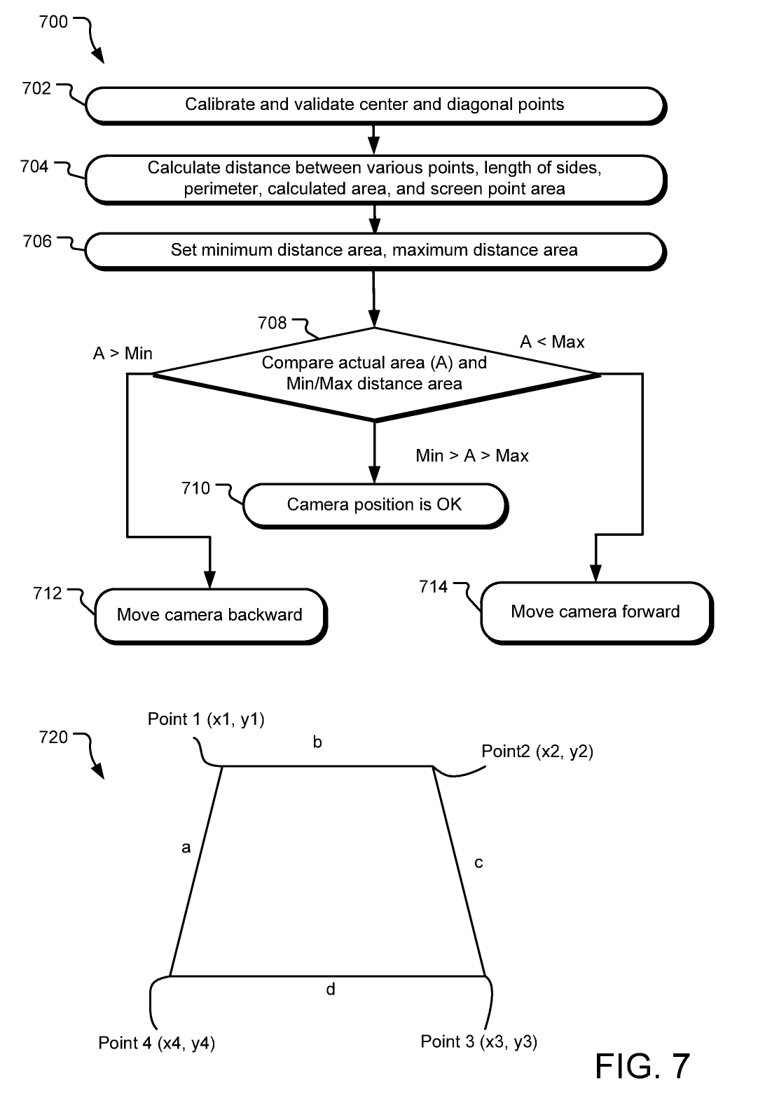

Subsequently other calibration points are also calibrated in a similar manner at operation 610. Specifically, the user presses the stylus to each of the other calibration points on the presentation surface, as identified by a laser illumination and the IR transmitter attached to the stylus sends an IR signal to the camera with IR signal sensor. Subsequently, a determination operation 612 determines if all calibration points are properly calibrated. If one or more of the calibration points are not calibrated properly, an operation 614 requires the user to move the camera as necessary until the calibration points are calibrated. The operations for determining whether it is necessary to move the camera are further illustrated below in FIG. 7.

If all calibration points are calibrated properly, an operation 616 turns off the laser and the calibration points are saved. Subsequently, an operation 618 uses the saved calibrations for the interactive documentation and presentation session.

An implementation of the presentation system disclosed herein requires the camera and the projector to be within a recommended tilt angle and within a recommended offset angle range for more effective performance. For example, such an implementation may require the permissible tilt angle for the IR capturing device to be less than thirty degrees from the horizontal surface (which is perpendicular to the presentation surface) and offset angle range to be within thirty degrees from a linear position parallel to the presentation surface.

FIG. 7 illustrates one or more operations 700 for adjustment of the position of camera used in the presentation system described herein. Specifically, an operation 702 calibrates and validates the center point and four diagonal points on the presentation surface. The four diagonal points are saved as point 1, point 2, point 3, and point 4 in the form of their x and y coordinates. In one implementation, any one of the points is taken as the origin point, with the co-ordinates of (0, 0) and the coordinates of the other three points are calculated in reference to the origin point. Each of the diagonal points represent one of four corners of a trapezoid with sides a, b, c, and d. Such a trapezoid 720 is illustrated in FIG. 7. An operation 704 calculates the distances between the various points, the length of each sides a, b, c, and d, of the trapezoid the perimeter of the trapezoid, and the calculated area of the trapezoid. In one implementation, the calculated area is calculated using a Brahmgupta's formula. However, alternate formulas can also be used.

Specifically, the formulas used for calculating the above measures are as follows:

Semi Perimeter s=(a+b+c+d)/2

Calculated Area A=SQRT((s−a)(s−b)(s−c)(s−d))

A screen point area of the trapezoid or rectangle is also calculated.

Subsequently, an operation 706 sets the minimum distance area limit (MIN) as 80% of the screen point area and a maximum distance area (MAX) limit as 11% of the screen point area. An operation 708 compares the values of the MIN and MAX with the calculated area A. If the calculated area A is greater than the minimum distance area limit (MIN), an instruction is generated for the user to move the camera forward 714. If the calculated area A is less than the maximum distance area limit (MAX), an instruction is generated for the user to move the camera backward 712. If the calculated area A falls between the minimum distance area limit (MIN) and the maximum distance area limit (MAX), the camera position is acceptable.

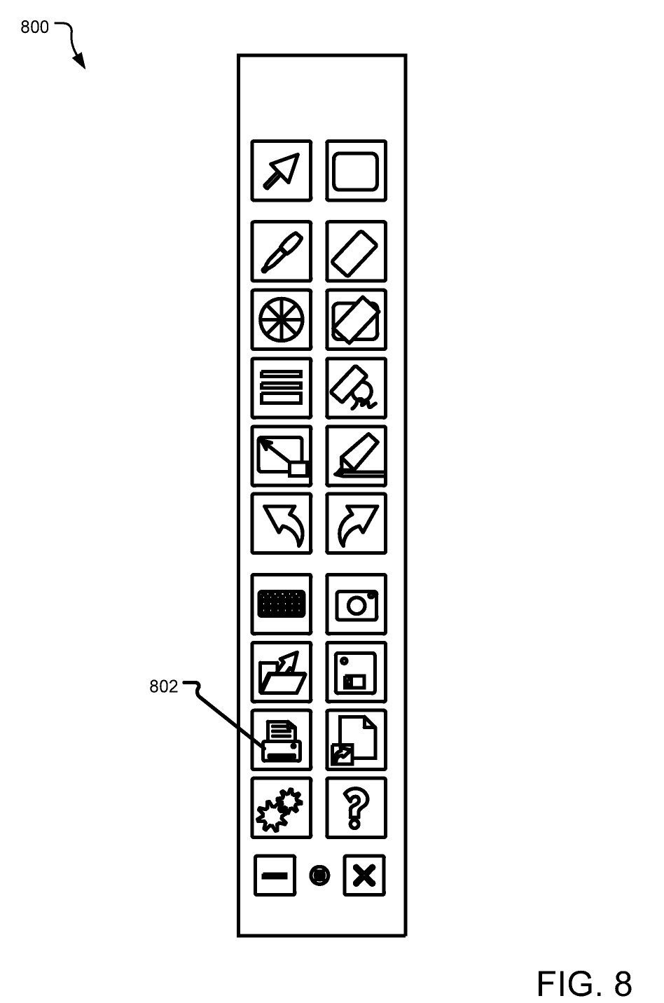

Once the calibration process and the camera placement process are complete, a user is able to use the capabilities of the presentation system disclosed herein. In one implementation, a number of feature options are projected on the presentation surface and the user is able to select one of this options by pressing a stylus tip on the feature option. As the user selects one of these selection options, the IR transmitter on the stylus sends an IR signal to the IR capturing device, which in turn sends the information about the type of the IR signal, the position of the IR signal, etc., to a computer. The computer correlates the position information with the projected selection option and performs an action accordingly. FIG. 8 illustrates an option menu 800 including a collection of such feature options that may be provided to the user of the presentation system disclosed herein. For example, a user can press the stylus on a “Print” option 802 to print a currently open document. In one implementation, a submenu is presented to the user upon his pressing some of the options from the options menu 800. In an alternative implementation, a user is able to add more selection or feature options to the menu 800 or to change the actions related to one or more of the selection options from the menu 800.

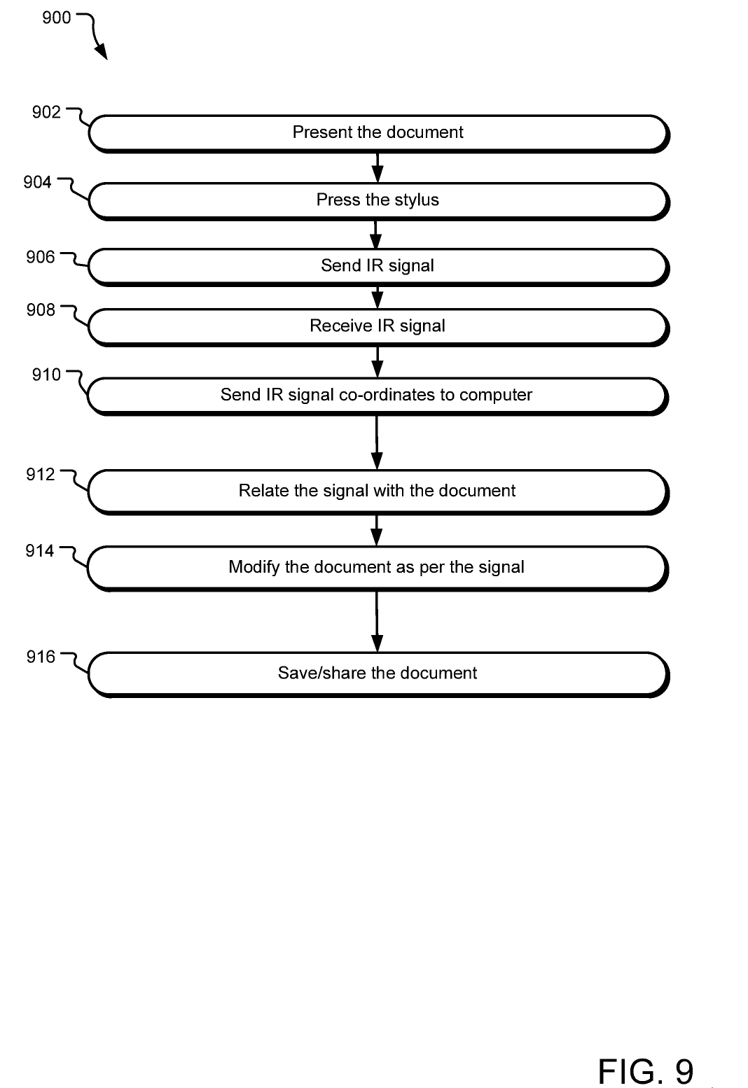

Now referring to FIG. 9, one or more operations for a document presentation and collaboration process 900 are illustrated. The process 900 can be used after the camera of the presentation system is calibrated and located at an acceptable location as compared to a presentation surface. At an operation 902, a presentation document stored on the computer is presented on the presentation surface. The presentation document may be, for example, a PowerPoint presentation, an Excel spreadsheet, etc. A user uses a stylus with an IR transmitter to make one or more changes to the presentation document. At operation 904, the user presses a stylus at a particular location on the document on the presentation surface. An operation 906 sends an IR signal from the stylus to a camera capable of capturing and processing the IR signal. Once the IR signal is received at operation 908, the camera sends 910 information about the IR signal, such as the type of the signal, the location of the stylus when the signal was generated, etc., to the computer. Since, the stylus acts as a utility tool that can be used as a substitute or as a complement to computer mice, use of the stylus virtually allows the user to interact with other applications utilizing the presentation and documentation system disclosed herein.

At operation 912, the computer relates the IR signal to the document based on the information received from the IR camera. For example, if the current document is an Excel file and the location of the stylus indicates a particular cell in a worksheet, the computer makes that particular cell in the Excel worksheet active. If the stylus movement suggests any modification of the document, such as a mark-up, an addition of a number, etc., at an operation 914 the computer modifies the document accordingly. Subsequently, at an operation 916, the updated document may be shared with other users or saved for future use.

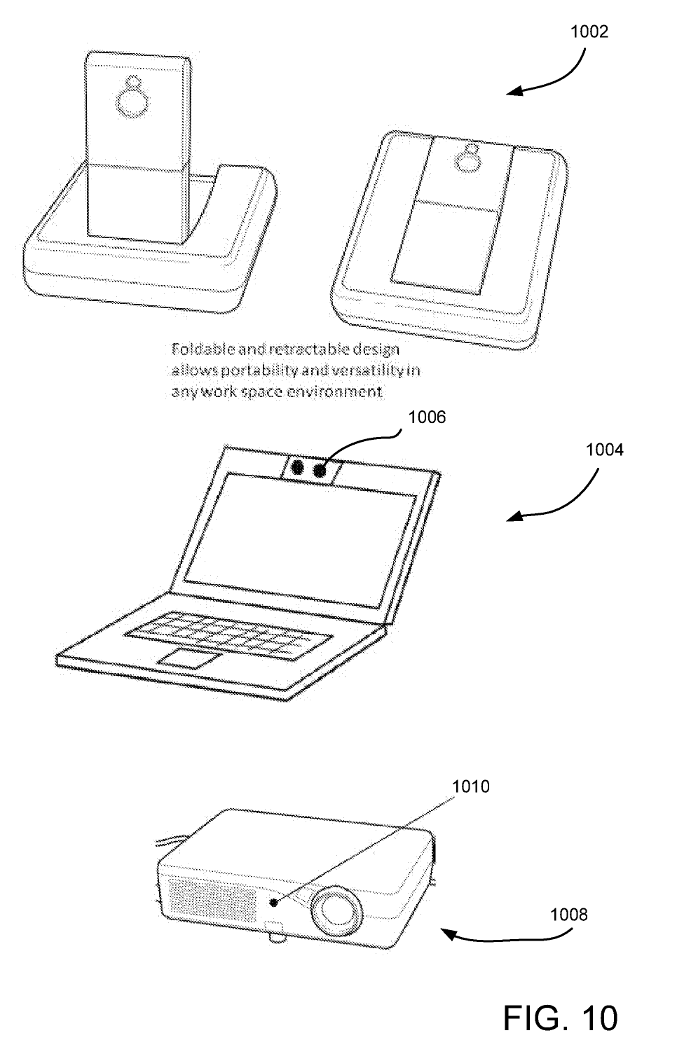

FIG. 10 illustrates alternate implementations of various apparatuses used with the presentation system disclosed herein. Specifically, 1002 illustrates an implementation of a camera with a CMOS sensor, wherein the camera can be folded into and retracted from a cradle that houses microcontroller for processing camera output. A laptop computer 1004 with a camera 1006 may be provided with IR sensing capabilities and the capabilities for processing the signals from the IR camera. In such an implementation, no separate camera connected to the computer is required. Similarly, a projector 1008 may be provided with camera 1010 that is used in place of a separate camera for the presentation system.

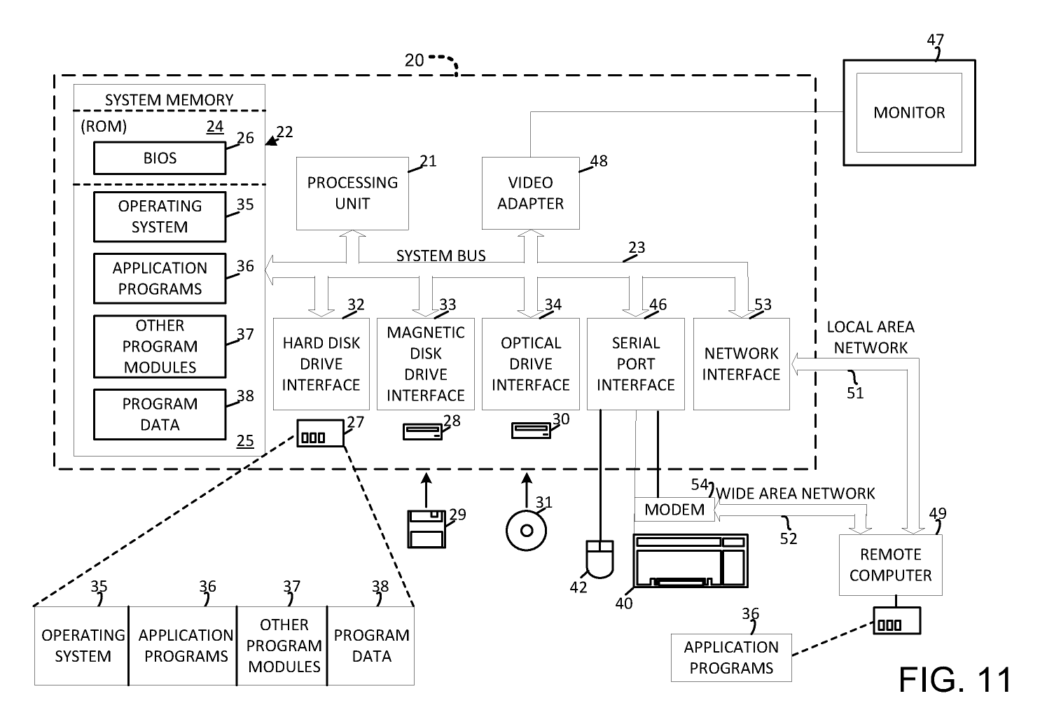

FIG. 11 illustrates an example computing system that can be used to implement the described technology. A general-purpose computer system 1100 is capable of executing a computer program product to execute a computer process. Data and program files may be input to the computer system 1100, which reads the files and executes the programs therein. Some of the elements of a general-purpose computer system 1100 are shown in FIG. 11 wherein a processor 1102 is shown having an input/output (I/O) section 1104, a Central Processing Unit (CPU) 1106, and a memory section 1108. There may be one or more processors 1102, such that the processor 1102 of the computer system 1100 comprises a single central-processing unit 1106, or a plurality of processing units, commonly referred to as a parallel processing environment. The computer system 1100 may be a conventional computer, a distributed computer, or any other type of computer. The described technology is optionally implemented in software devices loaded in memory 1108, stored on a configured DVD/CD-ROM 1110 or storage unit 1112, and/or communicated via a wired or wireless network link 1114 on a carrier signal, thereby transforming the computer system 1100 in FIG. 11 to a special purpose machine for implementing the described operations.

The I/O section 1104 is connected to one or more user-interface devices (e.g., a keyboard 1116 and a display unit 1118), a disk storage unit 1112, and a disk drive unit 1120. Generally, in contemporary systems, the disk drive unit 1120 is a DVD/CD-ROM drive unit capable of reading the DVD/CD-ROM medium 1110, which typically contains programs and data 1122. Computer program products containing mechanisms to effectuate the systems and methods in accordance with the described technology may reside in the memory section 1104, on a disk storage unit 1112, or on the DVD/CD-ROM medium 1110 of such a system 1100. Alternatively, a disk drive unit 1120 may be replaced or supplemented by a floppy drive unit, a tape drive unit, or other storage medium drive unit. The network adapter 1124 is capable of connecting the computer system to a network via the network link 1114, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, gaming consoles, set top boxes, etc.

When used in a LAN-networking environment, the computer system 1100 is connected (by wired connection or wirelessly) to a local network through the network interface or adapter 1124, which is one type of communications device. When used in a WAN-networking environment, the computer system 1100 typically includes a modem, a network adapter, or any other type of communications device for establishing communications over the wide area network. In a networked environment, program modules depicted relative to the computer system 1100 or portions thereof, may be stored in a remote memory storage device. It is appreciated that the network connections shown are exemplary and other means of and communications devices for establishing a communications link between the computers may be used.

In an example implementation, the general-purpose computer system 1100 includes one or more components of the presentation system. Further, the plurality of internal and external databases, source database, and/or data cache on the cloud server are stored as memory 1108 or other storage systems, such as disk storage unit 1112 or DVD/CD-ROM medium 1110. Still further, some or all of the operations disclosed in FIGS. 1, 2, 3, and 10 are performed by the processor 1102. In addition, one or more operations of the presentation system be generated by the processor 1102 and a user may interact with the various devices of the presentation system using one or more user-interface devices (e.g., a keyboard 1116 and a display unit 1118). Furthermore, code for generating one or more of the presentation document, etc., may be stored on the memory section 1108.

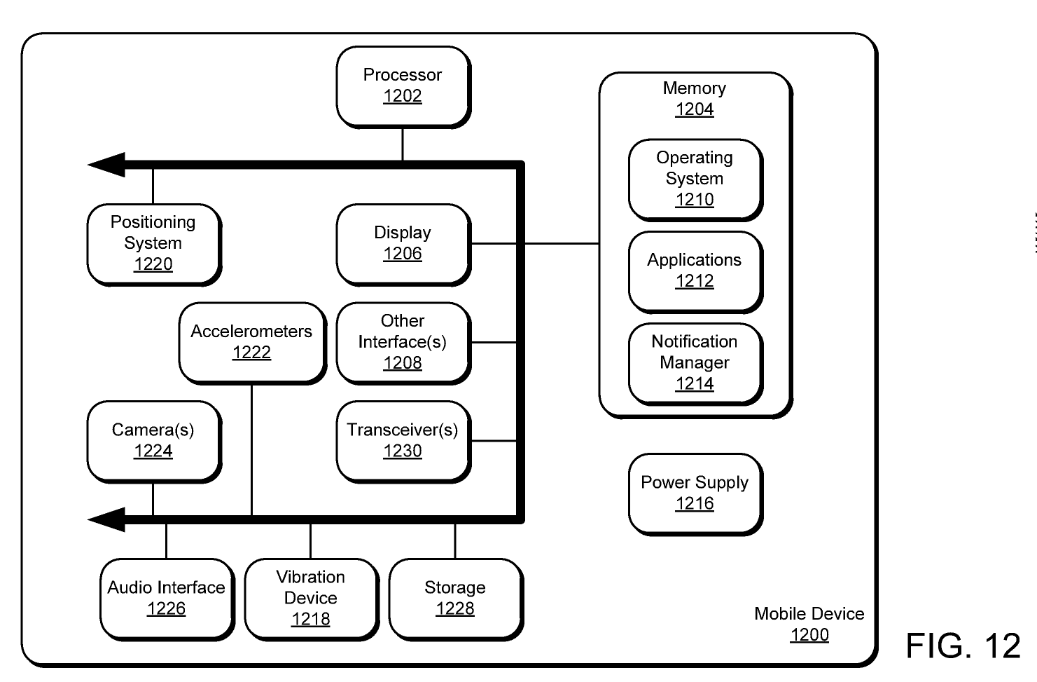

FIG. 12 illustrates another example system (labeled as a mobile device 1200) that may be useful in implementing the described technology. The mobile device 1200 includes a processor 1202, a memory 1204, a display 1206 (e.g., a touchscreen display), and other interfaces 1208 (e.g., a keyboard). The memory 1204 generally includes both volatile memory (e.g., RAM) and non-volatile memory (e.g., flash memory). An operating system 1210, such as the Microsoft Windows® Phone 7 operating system, resides in the memory 1204 and is executed by the processor 1202, although it should be understood that other operating systems may be employed.

One or more application programs 1212 are loaded in the memory 1204 and executed on the operating system 1210 by the processor 1202. Examples of applications 1212 include without limitation email programs, scheduling programs, personal information managers, Internet browsing programs, multimedia player applications, etc. A notification manager 1214 is also loaded in the memory 1204 and is executed by the processor 1202 to present notifications to the user. For example, when a promotion is triggered and presented to the shopper, the notification manager 1214 can cause the mobile device 1200 to beep or vibrate (via the vibration device 1218) and display the promotion on the display 1206.

The mobile device 1200 includes a power supply 1216, which is powered by one or more batteries or other power sources and which provides power to other components of the mobile device 1200. The power supply 1216 may also be connected to an external power source that overrides or recharges the built-in batteries or other power sources.

The mobile device 1200 includes one or more communication transceivers 1230 to provide network connectivity (e.g., mobile phone network, Wi-Fi®, BlueTooth®, etc.). The mobile device 1200 also includes various other components, such as a positioning system 1220 (e.g., a global positioning satellite transceiver), one or more accelerometers 1222, one or more cameras 1224, an audio interface 1226 (e.g., a microphone, an audio amplifier and speaker and/or audio jack), and additional storage 1228. Other configurations may also be employed.

In an example implementation, a presentation system, and other modules and services may be embodied by instructions stored in memory 1204 and/or storage devices 1228 and processed by the processing unit 1202. Various programs for the presentation system and other data may be stored in memory 1204 and/or storage devices 1228 as persistent datastores.

In the above description, for the purposes of explanation, numerous specific details are set forth in order to provide a thorough understanding of the technology described herein. The technology described herein may be practiced without some of these specific details. For example, while various features are ascribed to particular implementations, it should be appreciated that the features described with respect to one implementation may be incorporated with other implementations as well. Similarly, however, no single feature or features of any described implementation should be considered essential to the technology described herein, as other implementations of the technology described herein may omit such features.

In the interest of clarity, not all of the routine functions of the implementations described herein are shown and described. It will, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one implementation of the technology described herein, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one implementation of the technology described herein, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the technology described herein, the term “processor” describes a physical computer (either stand-alone or distributed) or a virtual machine (either stand-alone or distributed) that processes or transforms data. The processor may be implemented in hardware, software, firmware, or a combination thereof.

In the context of the technology described herein, the term “data store” describes a hardware and/or software means or apparatus, either local or distributed, for storing digital or analog information or data. The term “data store” describes, by way of example, any such devices as random access memory (RAM), read-only memory (ROM), dynamic random access memory (DRAM), static dynamic random access memory(SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The implementations of the technology described herein are implemented as logical steps in one or more computer systems. The logical operations of the technology described herein are implemented (1) as a sequence of processor-implemented steps executing in one or more computer systems and (2) as interconnected machine or circuit modules within one or more computer systems. The implementation is a matter of choice, dependent on the performance requirements of the computer system implementing the technology described herein. Accordingly, the logical operations making up the implementations of the technology described herein described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary implementations of the technology described herein. Since many implementations of the technology described herein can be made without departing from the spirit and scope of the technology described herein, the technology described herein resides in the claims hereinafter appended. Furthermore, structural features of the different implementations may be combined in yet another implementation without departing from the recited claims. The implementations described above and other implementations are within the scope of the following claims.

What is claimed is:

1. A method, comprising:
calibrating a plurality of points from a projection surface to a plurality of points on a camera view;
projecting content of a document on the projection surface;
receiving a light signal from a stylus, processing the light signal to map a position of the stylus on the projection surface; and
generating a first change in the document based on the position of the stylus on the projection surface.

2. The method of claim 1, wherein the light signal is generated by a light emitting diode (LED) on the stylus.

3. The method of claim 1, wherein the plurality of points include a central point, four corner points, and four internal diagonal points.

4. The method of claim 1, wherein calibrating the plurality of points further comprises calibrating nine points from the projection surface to nine points on the camera view.

5. The method of claim 1, wherein calibrating one of the plurality of points further comprising:
projecting a laser to the one of the plurality of points;
receiving the light signal from the stylus; and
associating the location of the stylus with the one of the plurality of points.

6. The method of claim 1, wherein receiving the light signal from the stylus further comprises receiving the light signal in response to pressing a first switch of the stylus to the presentation surface.

7. The method of claim 1, wherein receiving the light signal from the stylus further comprises receiving the light signal in response to moving the stylus within a predetermined proximity of the presentation surface.

8. The method of claim 1, further comprising:
projecting a plurality of selection options on the presentation surface;
receiving a selection signal from the stylus selecting one of the plurality of selection options; and
performing a first action in response to the selection signal.

9. The method of claim 7, wherein one of the selection options is to save the document including the first change in the document.

10. The method of claim 1, wherein the light signal is an IR signal generated by pressing a button on the stylus.

11. The method of claim 1, wherein receiving the light signal comprises receiving the light signal by a CMOS sensor.

12. A stylus device comprising:
a first surface having a light signal emitting device thereon, the light signal emitting device configured to generate a light signal;
a second surface having an activation switch, wherein the activation switch is configured to activate the light signal emitting device upon at least one of (1) pressing the activation switch on a projection surface; and (2) getting the activation switch in close proximity to a projection surface.

13. The stylus device of claim 12, wherein the first surface is substantially curved and at an angle from the second surface such that when the activation switch is pressed on the presentation surface, the light signal emitting device sends the light signal via a line of sight away from the presentation surface.

14. The stylus device of claim 13, wherein the light signal emitting device is configured to generate an infrared (IR) signal.

15. The stylus device of claim 13, wherein the light signal emitting device is configured to generate the light signal having a predetermined sequence and timing related to a specific code that, when processed by a capturing device, generates a first predetermined action on a computing device.

16. A system, comprising:
a projector device for projecting an image on a presentation surface;
a stylus device configured to generate a light signal;
a capturing device configured to receive the light signal from the stylus device; and
a processing device configured to process the light signal to determine the position of the stylus device on a presentation surface.

17. The system of claim 16, wherein the stylus device is further configured to generate an infrared light signal using a light emitting diode (LED).

18. The system of claim 16, further comprising a laser generation device configured to project a laser signal at a predetermined location on the presentation surface and the processing device is further configured to associate the position of the stylus device with the predetermined location on the presentation surface.

19. The system of claim 16, wherein the stylus device is further configured to generate the light signal in response to the pressing of a first switch of the stylus to the presentation surface.

20. The system of claim 16, further comprising generating a change in the image on a computing device based on the position of the stylus device on the presentation surface.
